(19) United States
(12) Patent Application Publication
(10) Pub. No.: US 2012/0054122 A1
(43) Pub. Date: Mar. 1, 2012

(54) METHOD AND SYSTEM FOR RENDERING A SHIPPING LABEL INCLUDING AN INDICIUM USING A MAILING MACHINE AND WEB SERVER

(75) Inventors: Joseph D. Mallozzi, Trumbull, CT (US); Michael J. Ramadei, Trumbull, CT (US); Michael W. Wilson, Trumbull, CT (US); Gary J. Steward, Easton, CT (US); Colin Goodwin, Ottawa (CA)

(73) Assignee: Pitney Bowes Inc., Stamford, CT (US)

(21) Appl. No.: 12/869,036

(22) Filed: Aug. 26, 2010

(51) Int. Cl. G07B 17/00

(52) U.S. Cl. 705/408

(57) ABSTRACT

Methods and systems for rendering a shipping label, including an indicium that evidences payment for delivery, for a mail piece using a mailing machine and remote web server. Parameter information for a mail piece are input to a mailing machine, which determines the fees required for delivery of the mail piece. The mailing machine generates indicium data based on the determined fee with appropriate security measures, which is sent from the mailing machine to a remote web server operated by the carrier. The web server renders a shipping label, including all information required by the carrier, along with the indicium data, in a printable format. The data for the shipping label is sent to the mailing machine. Accounting registers maintained in the mailing machine are debited for the determined fees, and a shipping label is printed using a printing device associated with the mailing machine.

### FIELD OF THE INVENTION

The invention disclosed herein relates generally to systems, and more particularly to methods and systems for rendering a shipping label including an indicium that evidences fee payment associated with delivery of a mail piece using a mailing machine and remote web server.

### BACKGROUND OF THE INVENTION

Mailing systems for printing postage indicia on envelopes and other forms of mail pieces have long been well known and have enjoyed considerable commercial success. There are many different types of mailing systems, ranging from relatively small units that handle only one mail piece at a time, to large, multi-functional units that can process hundreds of mail pieces per hour in a continuous stream operation. The larger mailing systems often include different modules that automate the processes of producing mail pieces, each of which performs a different task on the mail piece. The mail piece is conveyed downstream utilizing a transport mechanism, such as rollers or a belt, to each of the modules. Such modules could include, for example, a singulating module, i.e., separating a stack of mail pieces such that the mail pieces are conveyed one at a time along the transport path, a moistening/sealing module, i.e., wetting and closing the glued flap of an envelope, a weighing module, and a metering module, i.e., applying evidence of postage to the mail piece. The exact configuration of the mailing system is, of course, particular to the needs of the user.

Typically, a control device, such as, for example, a microprocessor, performs user interface and control functions for the mailing system. Specifically, the control device provides all user interfaces, executes control of the mailing system and print operations, calculates postage for debit based upon rate tables, provides the conduit for a Postal Security Device (PSD) to transfer information defining postage indicia or a digital postage mark (DPM) to the printer, operates with peripherals for accounting, printing and weighing, and conducts communications with a data center for postage funds refill, software download, rates download, and market-oriented data capture. The control device, in conjunction with an embedded PSD, constitutes the system meter that, for example, satisfies U.S. information-based indicia program (IBIP) meter requirements and other international postal regulations regarding meters.

In some situations in which special carrier services are desired, it is not possible to use the mailing machine to generate a complete shipping label, as information must be provided by the carrier for inclusion in the shipping label. In such situations, it is necessary to utilize some other service to generate the shipping label.

### SUMMARY OF THE INVENTION

The present invention provides methods and systems for rendering a shipping label, including an indicium that evidences payment for delivery, for a mail piece using a mailing machine and remote web server. As used herein, mail piece means any type of letter, flat, parcel or package. Parameter information, e.g., weight, dimensions, delivery zone, services desired, etc., for a mail piece are input to a mailing machine. A processing device of the mailing machine determines the fees required for delivery of the mail piece based on the input parameter information. A PSD in the mailing machine generates indicium data based on the determined fees. The indicium data includes any necessary security information, e.g., postage amount, indicia serial number, postage class, special services, digital signatures, etc. The indicium data is sent, via a network, from the mailing machine to a remote web server operated by the carrier. The web server renders a complete shipping label, including all information required by the carrier, e.g., tracking number, special services identifiers, etc., along with the indicium data, in a printable format. The data for the printable format shipping label is sent from the remote web server, via the network, to the mailing machine. Accounting registers maintained in the PSD of the mailing machine are debited for the determined fees, and a shipping label is printed using a printing device associated with the mailing machine.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates in block diagram form a system for rendering a postal indicia and shipping label using a mailing machine and web server according to embodiments of the present invention;

FIGS. 2A and 2B illustrate in flow diagram form the operation of the system of FIG. 1 according to an embodiment of the present invention; and

FIG. 3 illustrates an example of a shipping label generated by the system of FIG. 1.

### DETAILED DESCRIPTION OF THE INVENTION

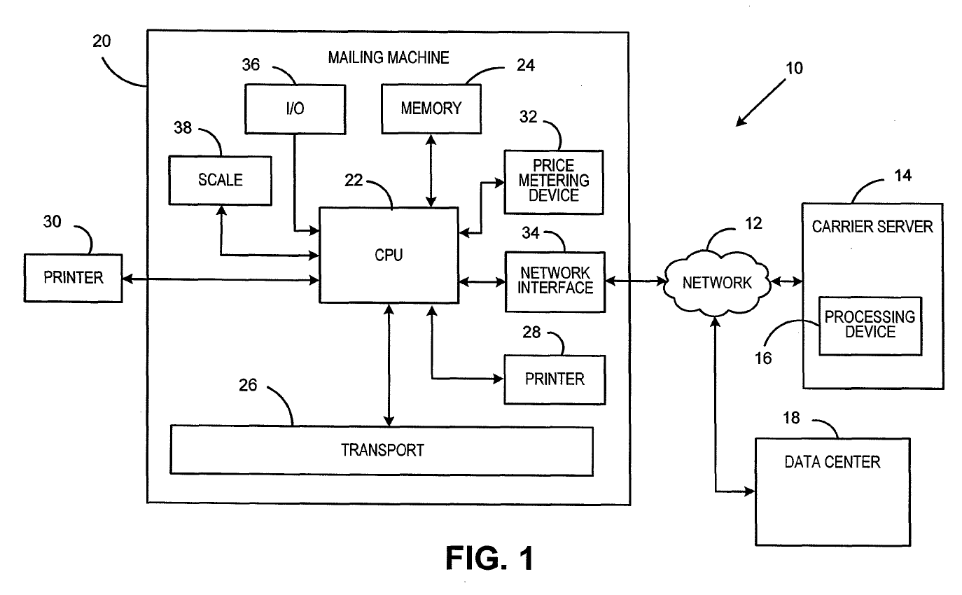

In describing the present invention, reference is made to the drawings, where there is seen in FIG. 1 in block diagram form a system 10 for rendering a shipping label including an indicium that evidences payment for delivery using a mailing machine and web server according to an embodiment of the present invention. System 10 includes a mailing machine 20 that is coupled to a network 12, such as, for example, the Internet, or any other type of communication network. A carrier server 14 is also coupled to the network 12. As used herein, a carrier can refer to any governmental carrier, e.g., United States Postal Service, or any commercial carrier. Carrier server 14 generally includes one or more processing devices 16, e.g., computer systems, and databases (not shown) that are utilized to provide services offered by the carrier that operates the carrier server 14. Users wishing to utilize such services can access the carrier server 14 using a processing device, e.g., personal computer or the like, via the network 12 to provide information to and receive information from the carrier server 14. Such servers are generally well known in the art and need not be discussed further here for an understanding of the present invention.

Mailing machine 20 is a dedicated mailing machine that is utilized to process outgoing mail pieces. There are many different types of mailing machines, ranging from relatively small units that handle only one mail piece at a time, to large, multi-functional units that can process hundreds of mail pieces per hour in a continuous stream operation. Mailing machine 20 includes a central processing unit 22, which can include, for example, one or more special or general purpose processing devices. The CPU 22 controls operation of the mailing machine 20 using instructions stored in one or more memory units 24. An input/output (I/O) device 36 such as, for example, a keyboard, a display device, and/or a touch screen, is provided to allow an operator to provide inputs to and receive information from the CPU 22. The mailing machine 20 includes a transport 26, which may be, for example, conventional rollers and/or belts, that transports mail pieces in seriatim fashion through the mailing machine 20 and past a printer 28 for printing of an indicium that evidences payment of appropriate delivery fees thereon. Such transport systems are well known in the art.

When processing mail pieces, the CPU 22 communicates with a metering device 32 that is utilized to generate indicia to evidence payment for delivery of mail pieces and provide accounting data for communication to a remote data center 18 via the network 12. A network interface 34 provides the necessary communication hardware/software required for the mailing machine 20 to communicate with other devices, such as the carrier server 14 or the data center 18, via the network 12. A metering device 32, also referred to as a postal security device (PSD), is coupled to the CPU 22. Metering device 32 is preferably a secure coprocessor that performs cryptographic operations and keeps track of funds for use in evidencing payment for delivery of mail pieces by maintaining a descending register, which stores an amount of funds available for use, and an ascending register, which stores a total amount of funds dispensed over the life of the metering device 32. Funds may be added to the descending register by any conventional means, including downloading from the data center 18 via the network 12.

Metering device 32 may further include rating functionality, preferably in the form of a software module, that contains the necessary information pertaining to the rating system of the carriers supported by the mailing machine 20, thereby allowing the mailing machine 20 to determine the proper fees required by a carrier for delivery of a mail piece using one or more of the services offered by the carrier. Alternatively a rating module could be stored in the memory 24 and utilized by the CPU 22 to determine the rate for a mail piece, and this information provided to the metering device 32. The printer 28 is used to print information, such as, for example, indicia generated by the metering device 32, address information (either or both of the sender and recipient), ad slogans, and the like. Printer 28 may be, for example, an ink jet printer or other conventional type of printing device. Printer 28 is preferably adapted to print such information either directly on a mail piece, or alternatively on a tape that can be applied to a mail piece (for those mail pieces that are too large to be processed using the transport 26). Printer 28 could also be utilized to print receipts for processed mail or other types of reports associated with processed mail. A peripheral printing device 30 could also be coupled to the mailing machine 20 that can be used to print receipts, other types of reports, or labels that may not be able to be printed by printer 28. The mailing machine 20 can also include one or more scales 38 that can be used to weigh mail pieces being processed by the mailing machine 20. The scale 38 may be integral with the transport 26 such that letters can be weighed as they are being transported. The scale 38 may also include a platform scale that can be used to weigh mail pieces that are too large to be processed through the mailing machine 20 using the transport 26.

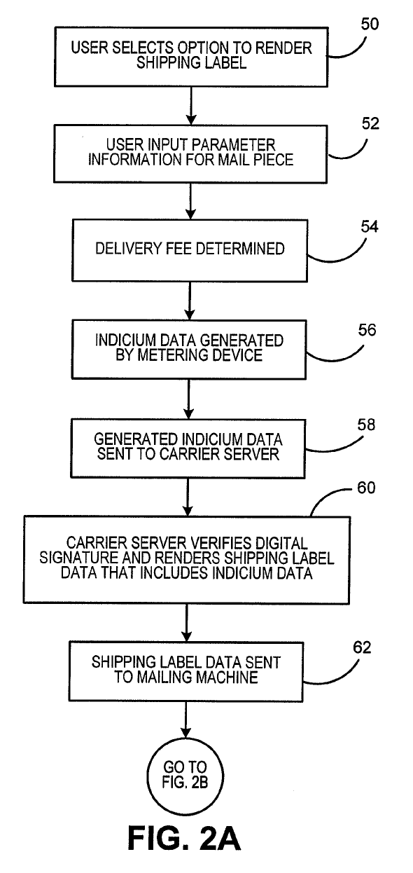

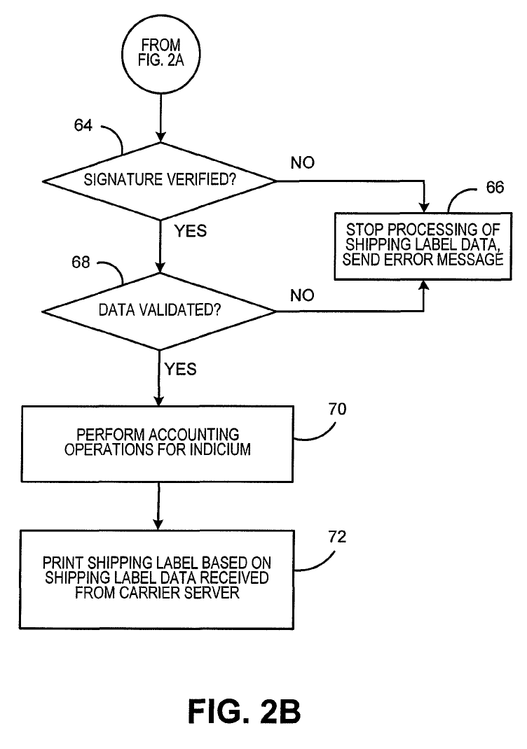

Referring now to FIGS. 2A and 2B, there is illustrated in flow diagram form the operation of the system of FIG. 1 to render a shipping label including an indicium that evidences payment for delivery of a mail piece according to an embodiment of the present invention. In step 50, a user of the mailing machine 20 indicates a desire to render a shipping label for a mail piece by selecting a shipping label option using, for example, the I/O device 36. In step 52, the user inputs parameter information for the mail piece again using, for example, the I/O device 36. Such parameter information could include, for example, the carrier desired to deliver the mail piece, the service level to be provided by the carrier, e.g., overnight, two day, etc., the weight of the mail piece (which may be determined using the scale 38), the dimensions of the mail piece, the destination location (e.g., address, zip code or the like) special services being requested, e.g., tracking, insurance, etc., and any other information required to determine the fees required for delivery of the mail piece. In step 54, the fee for delivery of the mail piece is obtained by the mailing machine 20. The fee can be determined using the parameter information received in step 52 and rating information stored within the mailing machine 10, e.g., in the memory 24 or a memory of the metering device 32. The rating calculation can be performed, for example, by the CPU 22 or the metering device 32, or by the processing device 16 of the carrier server 14 and returned to the CPU 22.

In step 56, the metering device 32 generates indicium data using the rating information determined in step 54. Indicium data is used to generate a respective indicium that evidences payment to be generated and printed. An indicium typically consists of a two-dimensional (2D) barcode and certain human-readable information. The indicium data, which is typically contained in the barcode and may also be provided in the human-readable information, includes, for example, the PSD manufacturer identification, PSD model identification, PSD serial number, values for the ascending register (the total monetary value of all indicia ever produced by the PSD) and descending register (the postage value remaining on the PSD) of the PSD at the time of printing, fee amount, date of mailing, and a cryptographic digital signature. Note, however, that preferably accounting for the indicium data does not yet occur, i.e., there are no funds actually debited from the descending register. Such accounting will preferably occur later in the process as described further below. The digital signature is created by the PSD for each mail piece and placed in a digital signature field of the barcode. Several types of digital signature algorithms can be utilized, including, for example, the Digital Signature Algorithm (DSA), the Rivest Shamir Adleman (RSA) Algorithm, and the Elliptic Curve Digital Signature Algorithm (ECDSA).

Each of the supported digital signature algorithms implements a “public key” cryptographic algorithm for the digital signature function. Public-key cryptosystems allow two parties to exchange private and authenticated messages without requiring that they first have shared a private (symmetric) key in a secure fashion. A public-key cryptosystem utilizes a unique pair of keys: a private key that is a secret and a public key that is widely known and can be obtained and used by any party without restrictions. This pair of keys has two important properties: (1) the private key cannot be deduced from knowledge of the public key and the message, and (2) the two keys are complementary, i.e., a message encrypted with one key of the pair can be decrypted only with the other (complementary) key of the pair. During manufacture or initialization of the PSD, a public/private key pair are generated and stored in nonvolatile memory in the PSD. The public key is then provided to a certificate authority, which generates a certificate for the public key that verifies the authenticity of the public key. The certificate is returned to the PSD, which compares the stored public key with the public key included in the certificate. If the comparison is successful, the certificate for the public key is stored by the PSD. The PSD then utilizes the private key to cryptographically sign indicia, which evidences payment of postage, produced by the PSD. The digital signature allows the postal service to authenticate each indicium, and provides assurance that proper accounting has been performed and payment has been made for delivery of a mail piece. To authenticate each indicium, the postal service utilizes the public key, in conjunction with the certificate for the public key, to verify the digital signature of the indicium. The digital signature allows the carrier service to authenticate each indicium, and provides assurance that proper accounting has been performed and payment has been made for delivery of a mail piece.

After the indicium data has been generated in step 56, then in step 58 it is sent from the mailing machine 20 to the carrier server 14 via the network 12. Preferably, the generated indicium data is signed with a digital signature by the metering device 32 using the private key of the metering device 32. Additionally, the communications between the mailing machine 20 and carrier server 14 are preferably secured, using, for example, Secure Socket Layer (SSL) protocol. Upon receipt of the indicium data, then in step 60 the carrier server 14 preferably will authenticate the indicium data by verifying the digital signature of the indicium data using the public key associated with the metering device 32. This provides assurances to the carrier server 14 that the metering device 32 is a valid metering device that is authorized to generate indicia data and request shipping labels. In addition, in step 60, the carrier server 14 renders data representative of a shipping label that includes the indicium data received from the mailing machine 20. Such shipping label data is preferably in a printable format such as, for example, PDF of TIFF. The shipping label data includes, in addition to the indicium data, other information added by the carrier server 14 such as, for example, information, markings, identifiers, and the like required by the carrier service for the type of service selected. The indicium data is preferably rendered as a two-dimensional barcode and human readable information, incorporated within the shipping label. In step 62, the shipping label data is sent from the carrier server 14 to the mailing machine 20 via the network 12. Optionally, the shipping label data can be signed with a digital signature using the public key of the metering device 32.

In step 64, the mailing machine 20 will verify the digital signature, if provided, for the shipping label data received from the carrier server 14. Such verification can be performed, for example, by the CPU 22. If the signature does not verify, then in step 66 the mailing machine 20 will not perform any further processing of the shipping label data and preferably provide a message to the carrier server 14 and/or the user of an error. Upon successful verification of the digital signature, then optionally in step 68 the mailing machine 20 can validate that the indicium included in the shipping label data corresponds to the indicium data that was sent to the carrier server 14 in step 58. This can be performed, for example, by comparing the indicium data included in the shipping label data with the indicium data sent to the carrier server 14. If the data does not validate, then in step 66 the mailing machine 20 will not perform any further processing of the shipping label data and preferably provide a message to the carrier server of an error and also preferably provide an error message to the user of the error. If the indicium is validated with respect to the indicium data in step 68 or if step 68 is not performed, then in step 70 the metering device 32 will account for the value of the indicium in the registers maintained by the metering device 32, i.e., the amount of funds included in the indicium will be debited from the descending register of the metering device 32, and the ascending register value will be incremented to include the value just dispensed. By delaying the actual accounting process until the shipping label data is received from the carrier server 14 and validated by the mailing machine 20, protection is provided for the user that funds will not be debited for an indicium that will not be printed. Thus, in the event that there is a failure in the communications, or the digital signatures do not verify or the data does not verify, the user's account is not charged for an indicium that will not be printed.

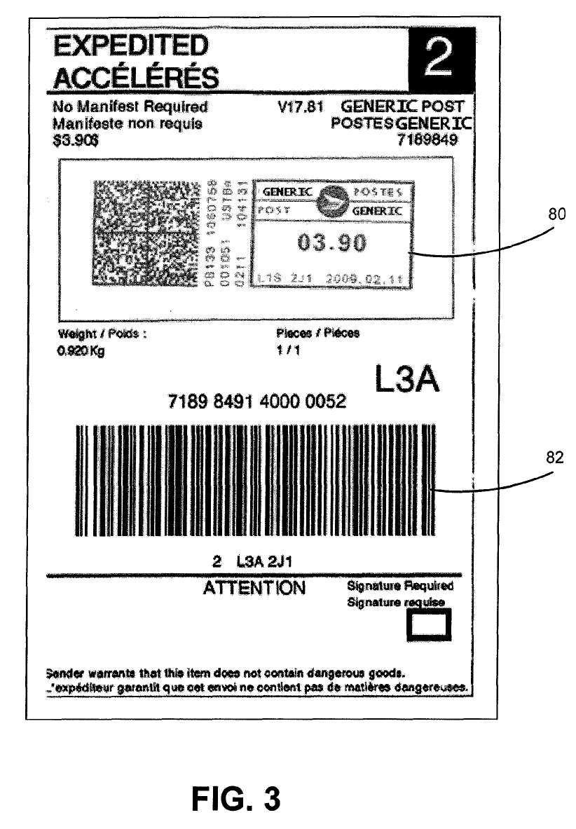

In step 72, the CPU 22 of the mailing machine 20 causes a shipping label that is based on the shipping label data received from the carrier server 14 to be printed using a printer associated with the mailing machine 20. The printer used to print the shipping label could be, for example, either the printer 28 or printer 30. FIG. 3 illustrates an example of a printed shipping label that includes an indicium 80 incorporated therein. The shipping label also includes information required based on the carrier and services, e.g., a tracking number 82. It should be understood that any other information required to be included in the label by the carrier can also be provided. By using the mailing machine 20 to generate the indicium data and the carrier server 14 to generate the shipping label, the user is able to obtain a complete shipping label that includes both an indicium that evidences payment along with information required by the carrier, based on the services selected for the mail piece, without having to maintain a separate billing account with the carrier server 14. The fees for the delivery of the mail piece are debited from the registers maintained in the mailing machine 20, instead of having to be charged to a credit card accepted by the carrier server 14 or having to establish and maintain a separate account with the carrier server 14.

By specifying a well established interface between hosted carrier services (e.g., additional carrier servers) and the mailing machine 20, potential multi-carrier systems can be formed be interfacing to the new carrier's infrastructure with minimal changes to the software of the mailing machine 20. Additionally, a shipping application may be hosted on a web server to provide common shipping label services across a group of mailing equipment as a means of minimizing operating costs of development of the various models of mailing machines. Utilizing the present invention, it is possible to achieve common architectures and centralization of key functions as web supported services.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for generating and printing a mailing label for a mail piece using a mailing machine, the mailing label including an indicium that evidences payment for delivery of the mail piece, the method comprising:
receiving by the mailing machine parameter information for the mail piece,
obtaining by the mailing machine a fee required for delivery of the mail piece to its intended destination;
generating by a metering device in the mailing machine indicium data, the indicium data including security information;
sending the generated indicium data from the mailing machine to a remote server via a network;
receiving by the mailing machine label image data for the mailing label for the mail piece from the remote server, the image data including an indicium that evidences payment of fees for delivery of the mail piece that is based on the indicium data sent to the remote server;
debiting a register maintained in the metering device in the mail processing machine for the fee required for delivery of the mail piece to its intended destination; and
printing, by a printing device associated with the mailing machine, the mailing label, including the indicium, based upon the label image data.

2. The method of claim 1, wherein before debiting a register occurs, the method further comprises:
validating that the indicium included in the label image data corresponds to the indicium data sent to the remote server.

3. The method of claim 1, wherein the security information includes a cryptographic signature.

4. The method of claim 1, wherein the label image data received from the remote server includes a digital signature, and the method further comprises:
verifying by the mailing machine the digital signature included with the label image data.

5. The method of claim 1, wherein obtaining by the mailing machine a fee required for delivery of the mail piece to its intended destination further comprises:
calculating by the mailing machine the fee required for delivery of the mail piece to its intended destination.

6. A method for a carrier server to render a shipping label comprising:
receiving at a processing device of the carrier server indicium data from a mailing machine remote from the carrier server;
generating by the processing device label data representative of a shipping label, the shipping label including an indicium based on the indicium data received from the mailing machine and other information added by the carrier server; and
sending the shipping label data from the carrier server to the mailing machine,
wherein accounting for the indicium is not performed at the carrier server.

7. The method of claim 6, further comprising:
generating a digital signature for the label data.
